(19) United States
(12) Patent Application Publication
(10) Pub. No.: US 2014/0184495 A1
(43) Pub. Date: Jul. 3, 2014

(54) Portable Device Input by Configurable Patterns of Motion

(71) Applicant: Joseph Patrick Quin, Norfolk, MA (US)

(72) Inventor: Joseph Patrick Quin, Norfolk, MA (US)

(21) Appl. No.: 14/145,741

(22) Filed: Dec. 31, 2013

Related U.S. Application Data
(60) Provisional application No. 61/747,489, filed on Dec. 31, 2012.

(51) Int. Cl. G06F 3/0346

(52) U.S. Cl. CPC G06F 3/0346
USPC 345/156

(57) ABSTRACT

A user-defined motion data pattern is used as input to a handheld computing device. The user-defined motion data pattern can be selectively associated with a corresponding input to the handheld computing device. The input may correspond to a particular command to perform a selected function that is executable by the portable computer device. The handheld computer device can acknowledge successful input of a motion and/or motion data pattern by providing tactile, audible and/or visual feedback.

### CROSS REFERENCE TO RELATED APPLICATIONS

This application claims priority to U.S. Provisional Patent Application No. 61/747,489 entitled Smartphone Input by Configurable Patterns of Motion, filed on Dec. 31, 2012, which is hereby incorporated by reference in its entirety.

### FIELD OF THE DISCLOSURE

The present disclosure is related to mobile computing devices and more particularly to motion sensed actuation of portable computing devices.

### BACKGROUND

Existing handheld computing devices such as tablet computers and smart phones include motion sensing components such as built-in accelerometers and gyroscopes. Currently, accelerometers in some handheld computing devices can measure or sense acceleration in three dimensions up to about 2.3 times gravitational acceleration (2.3 G). Currently, gyroscopes in some hand held computing devices can detect orientation changes of the device in three dimensions, i.e., around three axis. Some applications of handheld computing devices such as games use data from the accelerometer and/or gyroscope (together referred to as “motion data”) as control input.

### SUMMARY

According to aspects of the present disclosure, a user-defined motion data pattern can be used as input to a handheld computing device such as a tablet computer or smart phone, for example. The user-defined motion data pattern can be selectively associated with a corresponding input to the handheld computing device. The input may correspond to a password or other identifier, for example or may correspond to a particular command to perform a function that is executable by the portable computer device. According to one aspect of the present disclosure, a user can create their own motion alphabet or associate motion patterns with objects such as contacts, or with application actions, for example. According to an aspect of the present disclosure, a standard motion alphabet could be implanted and may be useful to enter data and or commands without looking at the device, (e.g., while driving). An optional audible and or tactile feedback can acknowledge successful input of a motion and/or motion data pattern.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a process flow diagram illustrating a method for controlling a portable computing device according to an aspect of the present disclosure.

FIG. 2 is a diagram conceptually illustrating an example of a portable computing device configurable to receive motion patters as input according to aspects of the present disclosure.

### DETAILED DESCRIPTION

A computing technique operable on a mobile computing device according to an aspect of the present disclosure includes recording motion data pattern to perform a particular task, such as to call a particular contact. According to an aspect of the present disclosure, a user may initiate the recording of a motion pattern by pressing a record button or icon or any other input including audible or motion input for example. The device provides an output as feedback to the user to acknowledge that it is ready to record a motion pattern. The user may the then performing a motion pattern with the device which is stored on the device or on a server in communication with the device. An example of a data pattern could be input, for example by the user tapping the device left side twice on cars dashboard, then tapping the device right side on the car's steering wheel one time. In one example, the user can press a done button to complete recording the motion pattern, or may access a contact list and/or an action list to associate an action with the recorded pattern. Tolerances and/or margins of error can be optionally adjustable and/or selectable by a user.

In one example, according to an aspect of the present disclosure, when the user wants to call a particular contact, the user performs a recorded motion pattern within a tolerance limit wherein the recorded motion pattern has been associated with the command “call [contact name]”. The portable computing device is programmed to recognize the motion pattern and, in response, to perform the action that is associated with the recorded data pattern, e.g., initiating a telephone call to the desired contact.

According to an aspect of the present disclosure, the portable computing device may be configured to provide audible, visual and/or tactile feedback, and which can optionally acknowledge that a motion and/or motion pattern within a tolerance has been recognized. In an illustrative embodiment, the type of acknowledgement feedback may be selectable by a user. In one example, an accelerometer with a certain tolerance may be used to distinguish between a dashboard tap and a steering wheel tap, when the pattern of motions includes tapping the portable computing device on a dash or steering wheel of a vehicle, for example.

According to an aspect of the present disclosure, a user may set up different motion patterns to call different contacts. Another pattern may involve the gyroscope, rather than the accelerometer. In one example, a user inputs a motion pattern by rotating the device. For example, the user may spin the device twice to the right and once to the left in a particular plane to implement a pattern. The pattern may also include a plane of orientation during the spins, for example, the pattern may include a motion in which the device is lying flat on a substantially horizontal plane such as the passenger seat or center console of a vehicle, for example to define a pattern (or input the pattern). According to an aspect of the present disclosure, the pattern can include both acceleration data and gyroscope (orientation) data, for example. The acceleration data may include rates of change to velocity in any direction, and may include impact or impulses of various magnitudes and directions, representing taps to the device case, for example.

In addition to motion sensing capability, portable computer devices are generally configured for determining their geographic location using technologies such as global positioning systems and/or other well-known wireless locating technologies. According to an aspect of the present disclosure, geographical location information accessible by the portable computing device can be combined with a motion pattern to define an input to the portable computing device as a function of location. For example, a convenient motion patterns may be associated with different functions depending on the location of the device. In an example of this implementation, the portable computing device can be configured so tapping the device on the steering wheel of a vehicle while the portable computing device is geographically located near a first location could initiate a telephone call to the first location, while performing the same tapping pattern on the steering wheel would initiate a telephone call to a second location when the portable computing device is located nearer to the second location.

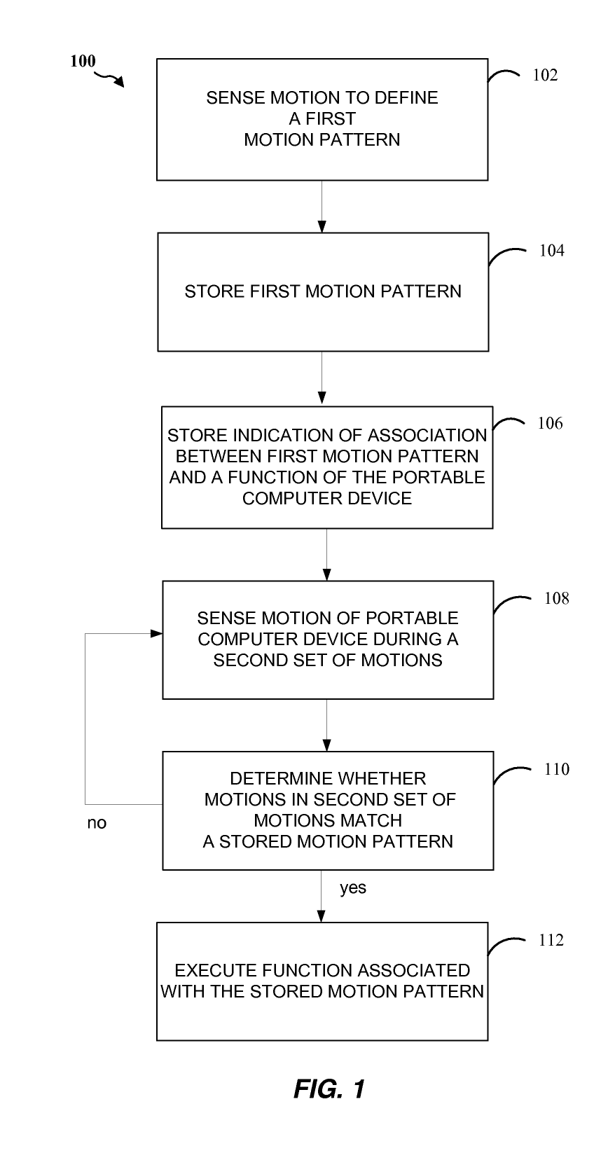

Aspects of the present disclosure are described with respect to the process flow diagram shown in FIG. 1. A method for controlling a portable computing device according to an aspect of the present disclosure includes sensing motion of a portable computing device while the portable computing device is subject to a first set of motions to define a first motion pattern in block 102, storing the first motion pattern in block 104, and storing an indication of association between the first motion pattern and a first selected function of the portable computing device in block 106. The first motion pattern may include motions such as accelerations, rotations and taps or directed impacts on the device case, for example. The first motion pattern may also include one or more delay durations between one or more of the motions.

According to an aspect of the present disclosure, the method includes sensing motion of the portable computing device while the portable computing device is subject to a second set motions in block 108, determining whether motions in the second set of motions correspond to motions in the first motion pattern in block 110 and executing the first selected function of the computing device when the second set of motions matches the first set of motions in block 112.

According to an aspect of the present disclosure, the method 100 may also include storing a corresponding tolerance for each motion in the first set of motions. In this aspect, the method may include sensing motion of the portable computing device while the portable computing device is subject to a second set motions, determining whether each of the motions in the second set of motions is within the corresponding tolerance relative to corresponding motions in the first motion pattern; and executing the first selected function of the computing device when each of the motions in the second set of motions is within the corresponding tolerance of matches the first set of motions, for example.

According to aspects of the present disclosure a stored tolerance may include a range of a parameter in which the parameters may include acceleration magnitude, acceleration direction, acceleration rate, rotation magnitude, rotation direction, rotation rate and geographic location, for example.

In another aspect of the present disclosure the method, 100 may also include storing a geographic location associated with the first selected function, and executing the first selected function of the portable computing device only when the portable computing device is within a predetermined range of the geographic location, for example.

In another aspect of the present disclosure, the method 100 may also include storing a first geographic location associated with the first selected function and the first motion pattern, storing a second geographic location associated with a second selected function and a third motion pattern, and executing either the first selected function or the second selected function based on whether the portable computing device is closer to the first geographic location or the second geographic location.

According to another aspect of the present disclosure, the method 100 may also include actuating an acknowledgement output in response to the second set of motions matching the first set of motions. The acknowledgement output may include tactile notification, an audible notification and/or a visual notification, for example. The type of feedback to be associated with a particular motion pattern and/or function may optionally be selectable by a user, for example.

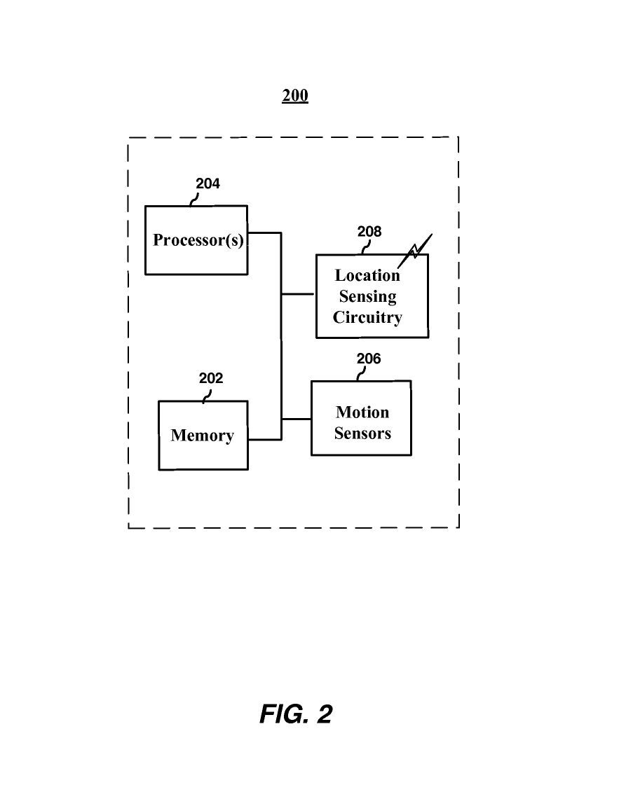

A portable computer device, according to an aspect of the present disclosure is described with reference to FIG. 2. The portable computer device 200 includes at least one memory 202, at least one processor 204 coupled to the memory 202, and at least one motion sensor 206 coupled to the processor 204. The motion sensors 206 may include an electronic accelerometer and/or an electronic gyroscope for example. The portable computer device 200 may also include location sensing circuitry 208, such as global positioning system (GPS) circuitry, for example.

According to aspects of the present disclosure, the portable computer device 200 is configured to sense motion of the portable computing device 200 while the portable computing device 200 is subject to a first set of motions to define a first motion pattern, to store the first motion pattern, and to store an indication of association between the first motion pattern and a first selected function of the portable computing device 200. According to aspects of the present disclosure, the portable computer device 200 is also configured to sense motion of the portable computing device 200 while the portable computing device 200 is subject to a second set motions, to determine whether motions in the second set of motions correspond to motions in the first motion pattern, and to execute the first selected function of the computing device when the second set of motions matches the first set of motions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “having,” “having,” “includes,” “including” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It should be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the present disclosure has been described in connection with the embodiments of the present disclosure illustrated in the accompanying drawings, it is not limited thereto. Persons with skill in the art will recognize that embodiments of the present disclosure may be applied to other types of memory devices. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for controlling a portable computing device, comprising:
sensing motion of a portable computing device while the portable computing device is subject to a first set of motions to define a first motion pattern;
storing the first motion pattern; and
storing an indication of association between the first motion pattern and a first selected function of the portable computing device.

2. The method of claim 1, further comprising:
sensing motion of the portable computing device while the portable computing device is subject to a second set motions;
determining whether motions in the second set of motions correspond to motions in the first motion pattern; and
executing the first selected function of the computing device when the second set of motions matches the first set of motions.

3. The method of claim 1, further comprising:
storing a corresponding tolerance for each motion in the first set of motions.

4. The method of claim 3, further comprising:
sensing motion of the portable computing device while the portable computing device is subject to a second set motions;
determining whether each of the motions in the second set of motions is within the corresponding tolerance relative to corresponding motions in the first motion pattern; and
executing the first selected function of the computing device when each of the motions in the second set of motions is within the corresponding tolerance of matches the first set of motions.

5. The method of claim 3, wherein the tolerance comprises a range of a parameter in the group consisting of acceleration magnitude, acceleration direction, acceleration rate, rotation magnitude, rotation direction, rotation rate and geographic location.

6. The method of claim 2, further comprising:
storing a geographic location associated with the first selected function; and
executing the first selected function of the portable computing device only when the portable computing device is within a predetermined range of the geographic location.

7. The method of claim 2, further comprising:
storing a first geographic location associated with the first selected function and the first motion pattern;
storing a second geographic location associated with a second selected function and a third motion pattern; and
executing either the first selected function or the second selected function based on whether the portable computing device is closer to the first geographic location or the second geographic location.

8. The method of claim 1, wherein the first motion pattern comprises motions in the group consisting of: accelerations, rotations and taps.

9. The method of claim 2, actuating an acknowledgement output in response to the second set of motions matching the first set of motions.

10. The method of claim 9, in which the acknowledgement output is in the group consisting of a tactile notification, an audible notification and a visual notification.

11. The method of claim 1, in which the first motion pattern comprises one or more delay durations between one or more of the motions.

12. A portable computer apparatus, comprising:
at least one memory;
at least one processor coupled to the at least one memory; and
at least one motion sensor coupled to the at least one processor;
wherein the portable computer apparatus is configured to:
sense motion of a portable computing device while the portable computing device is subject to a first set of motions to define a first motion pattern;
store the first motion pattern; and
store an indication of association between the first motion pattern and a first selected function of the portable computing device.

13. The apparatus of claim 12, further configured to:
sense motion of the portable computing device while the portable computing device is subject to a second set motions;
determine whether motions in the second set of motions correspond to motions in the first motion pattern; and
execute the first selected function of the computing device when the second set of motions matches the first set of motions.

14. The apparatus of claim 12, further configured to:
store corresponding tolerances for each motion in the first set of motions.

15. The apparatus of claim 14, further configured to:
sense motion of the portable computing device while the portable computing device is subject to a second set motions;
determine whether each of the motions in the second set of motions is within the corresponding tolerance relative to corresponding motions in the first motion pattern; and
execute the first selected function of the computing device when each of the motions in the second set of motions is within the corresponding tolerance of matches the first set of motions.

16. The apparatus of claim 14, wherein the tolerance comprises a range of a parameter in the group consisting of acceleration magnitude, acceleration direction, acceleration rate, rotation magnitude, rotation direction, rotation rate and geographic location.

17. The apparatus of claim 13, further configured to:
store a geographic location associated with the first selected function; and
execute the first selected function of the portable computing device only when the portable computing device is within a predetermined range of the geographic location.

18. The apparatus of claim 13, further configured to:
define a first geographic location associated with the first selected function and the first motion pattern;
define a second geographic location associated with a second selected function and a third motion pattern; and
execute either the first selected function or the second selected function based on whether the portable computing device is closer to the first geographic location or the second geographic location.

19. The apparatus of claim 13, further configured to:
actuate an acknowledgement output in response to the second set of motions matching the first set of motions.

20. The apparatus of claim 12, in which the first motion pattern comprises one or more delay durations between one or more of the motions.
